(19) United States
(12) Patent Application Publication
(10) Pub. No.: US 2021/0122647 A1
(43) Pub. Date: Apr. 29, 2021

(54) BALLAST WATER TREATMENT DURING DE-BALLASTING

(71) Applicant: Trojan Technologies Group ULC, London (CA)

(72) Inventors: Glen E. Latimer, JR., Chagrin Falls, OH (US); Allison Diane Miller, London (CA)

(21) Appl. No.: 16/667,756

(22) Filed: Oct. 29, 2019

(51) Int. Cl. C02F 1/00; B63J 4/00; C02F 1/32

(52) U.S. Cl. CPC C02F 1/004; B63J 4/002; C02F 2103/008; C02F 1/008; C02F 1/32

(57) ABSTRACT

An embodiment provides a ballast water treatment system, including: a ballast pump; a backwash pump, wherein an outflow of the backwash pump is mechanically coupled to an outlet of the ballast pump; a treatment unit, wherein the treatment unit is located fluidly between the ballast pump and the backwash pump; wherein the ballast water treatment system has at least two modes, comprising: a ballast mode, wherein, during the ballast mode, the ballast pump pumps water through the ballast treatment system to a ballast tank, and a de-ballast mode, wherein, during the de-ballast mode, the backwash pump conveys backwash water to an outlet of the ballast pump. Other aspects are described and claimed.

### FIELD

This application relates generally to ballast water treatment, and, more particularly, to the treatment of ballast water during de-ballasting.

### BACKGROUND

Ballast water may be used by ships to maintain the stability of a ship. If cargo is unloaded, ballast may be added to the ship to maintain stability for transit with less or no cargo aboard. Ballast water, when emptied, may introduce invasive species to a port or waterway. Governments around the world may govern the proper handling, storage, release, and the like, of ballast water. Thus, the proper treatment, filtration, and/or disinfection of ballast water may be needed to prevent the introduction of invasive species and/or contaminants to a body of water.

### BRIEF SUMMARY

In summary, one embodiment provides a ballast water treatment system, comprising: a ballast pump; a backwash pump, wherein an outflow of the backwash pump is mechanically coupled to an outlet of the ballast pump; a treatment unit, wherein the treatment unit is located fluidly between the ballast pump and the backwash pump; wherein the ballast water treatment system has at least two modes, comprising: a ballast mode, wherein, during the ballast mode, the ballast pump pumps water through the ballast treatment system to a ballast tank, and a de-ballast mode, wherein, during the de-ballast mode, the backwash pump conveys backwash water to an outlet of the ballast pump.

Another embodiment provides a method for ballast water treatment, comprising: during a ballast mode, pumping using a ballast pump, water through a ballast treatment system to a ballast tank, wherein the ballast treatment system comprises a treatment unit, wherein the treatment unit is located fluidly between the ballast pump and the backwash pump; and during a de-ballast mode, pumping using a backwash pump backwash water to an outlet of the ballast pump, wherein an outflow of the backwash pump is mechanically coupled to an outlet of the ballast pump.

A further embodiment provides a product, comprising: a storage device that stores code, the code being executable by a processor and comprising: code that during a ballast mode, pumps using a ballast pump, water through a ballast treatment system to a ballast tank, wherein the ballast treatment system comprises a treatment unit, wherein the treatment unit is located fluidly between the ballast pump and the backwash pump; and code that during a de-ballast mode, pumps using a backwash pump backwash water to an outlet of the ballast pump, wherein an outflow of the backwash pump is mechanically coupled to an outlet of the ballast pump.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example embodiment of a ballast water treatment system.

FIG. 2 illustrates a flow diagram of an example ballast water treatment system.

FIG. 3 illustrates an example of computer circuitry.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Conventional methods and systems for ballasting and de-ballasting water either pump ballast water into or out of a ship. Ballast water is typically sea water drawn from the sea during ballasting and sent overboard during de-ballasting. Sea water is a logical choice as it is plentiful and ever present, and sea water may be pumped into or out of ballast tank. Ballast water facilitates proper trim, stability, and structural integrity of a ship. If a ship has little or no cargo, the ship becomes lighter and rides higher in the water, which may affect stability. Thus, ballast water may be taken aboard for the purpose of stabilizing, trimming, or the like. If a ship has a full load of cargo, then the ballast water may be pumped or discharged overboard. Additionally, scenarios may exist when a ship has a partial cargo load and carries a partial ballast water load. Therefore, a ship may deliver a cargo load to a port and take on ballast water for a transit to pick up another load of cargo. At the port in which cargo is loaded, the ballast water may be discharged to account for the increased cargo load.

Conventional ballast systems do have environmental limitations. For example, a ship may ballast at one port and de-ballast at another port. The marine environment at the two ports may be very different. For example, a species of aquatic life present at a ballast port may not be present at the de-ballasting port. Species not native to an area and introduced may be referred to as invasive species or non-native marine species. These species may include algae, invertebrates, vertebrates, pathogens, or the like. Invasive species may disrupt a food chain, foul beaches, damage infrastructure, or the like. Thus, governments around the world have set requirements for the ballasting and de-ballasting of ships to control the spread of invasive species.

Many methods may be used to mitigate the release of invasive species during de-ballasting. For example, a ballast system may increase the filtration, increase the ultraviolet (UV) irradiation, hold the ballast water for a longer period of time, or the like. These methods require a higher cost, time of ballast holding, maintenance, or the like. However, conventional systems may still introduce invasive species through the backwash portion of the ballast system. For example, a conventional system may receive ballast water, treat the ballast water with a filter and UV, and pump the ballast water to a ballast tank. When de-ballasting, the ballast mater may be simply pumped overboard with little or no further treatment. Contamination in the ship system may cause the previously treated ballast water to become contaminated and, thus, contaminate the de-ballast port.

For a ballast treatment system to be effective, the ballast water may need to be treated at both the ballast and de-ballast modes of the system. What is needed is a ballast system that is easy to maintain, does not require any further largescale equipment, and may be retrofitted into existing ship systems. The system would eliminate or greatly reduce the risk of the introduction of invasive species, and meet current criteria set forth by governments worldwide for the treatment of ballast water.

Accordingly, an embodiment provides a device and method for the proper filtration of backwash water during ship ballast operations. In particular, backwash water may be filtered in a de-ballast mode and/or a ballast mode of operation. Ships may take aboard ballast water or de-ballast water based upon the cargo contained aboard the ship. Government regulations and environmental concerns maintain the need to properly treat ballast water to prevent cross contamination of bodies of water that a ship may visit. The device and method utilizes a backwash water pump. The backwash pump may have an outflow that fluidly conveys backwash water to an outlet of the ship ballast pump. Such a conveyance of backwash water to an outlet of the ballast pump may ensure that backwash water flows through the treatment unit of a ship. The treatment unit may include a filtration unit and/or a disinfection unit. The backwash water pump may be oversized as compared to a conventional backwash pump, thus, allowing the backwash pump to be capable of creating a pressure of the backwash water to overcome the pressure of the ballast pump. The system may also include a drain isolation valve that is located downstream of the backwash pump. The drain isolation valve may be a ball valve, butterfly valve, or the like. The drain isolation valve may be used to control the flow and/or pressure of the backwash water that is fluidly conveyed to the outlet of the ballast pump. The backwash pump may help to boost ballast water during a ballasting mode of operation. The backwash pump may also be used to drain or flush the ballast water treatment system.

The illustrated example embodiments will be best understood by reference to the figures. The following description is intended only by way of example, and simply illustrates certain example embodiments.

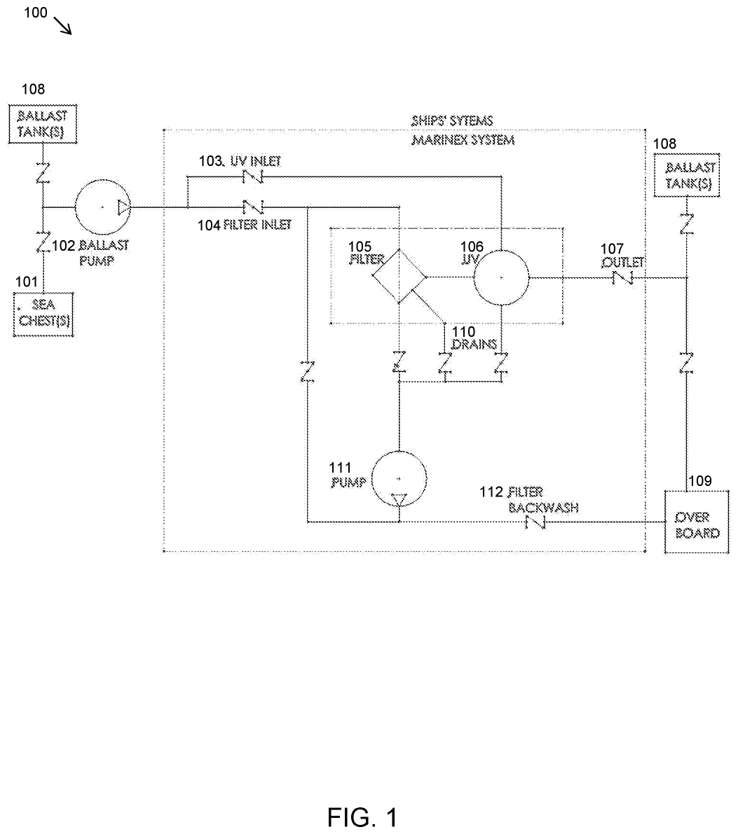

Referring to FIG. 1, an example device and method for ballast water treatment is illustrated. The method or device 100 may be used for ballasting or de-ballasting of a ship. The ballasting or de-ballasting may be selected based upon the amount of cargo aboard the ship to improve the stability, trim, and/or structural integrity of a ship.

In a ballast mode of operation, seawater may be pumped from a sea chest 101, using a ballast pump 102. The seawater may be referred to as ballast water or water. Once the system receives the ballast water, the ballast water may be sent to an inflow port of a treatment unit. The treatment unit may comprise a UV inlet 103 fluidly connected to a UV treatment unit 106. The treatment unit may comprise a filter inlet 104 fluidly connected to a filter treatment unit 105. The outflow of the treatment unit may be an outlet 107, drains 110, be fluidly connected to a pump or backwash pump 111, or a combination thereof. The backwash pump 111 may be of a large enough size and a high enough capacity to overcome the pressure from the ballast pump 102. In a ballast mode, the system may pump ballast water from the treatment unit to one or more ballast tanks 108. The ballast tanks may be located in various locations of a ship for stabilization, trimming, or the like. In this manner, ballast water from the surrounding the ship and/or sea chest may be properly treated prior to entering the one or more ballast tanks. Additionally or alternatively, ballast water coming out from the treatment unit may pass through a pump or backwash pump 111. This ballast water may be referred to as filter backwash 112 and travel from the backwash pump through one or more valves to an inlet of the ballast treatment system downstream of the ballast pump. The filter backwash may receive ballast water from a filter. The filter backwash may flow to a filter.

In a de-ballast mode, the ballast water in the one or more ballast tanks 108 may be dumped or pumped overboard 109. In addition to a ballast and a de-ballast mode, the method and device may have a pump 111 or a backwash pump. The back wash pump 111 may operate in both a ballast and/or a de-ballast mode. The system may also have a drain isolation valve. The drain isolation may be a ball valve, butterfly valve, or the like. The drain isolation may serve to regulate the flow or pressure of the filter back wash 112.

In an embodiment, the system may take backwash water during a de-ballast mode and fluidly communicate the backwash water to an outlet of the ship ballast pump or to an inlet of the ballast water treatment system. In an embodiment, the backwash pump may be sized properly to overcome a pressure from the ship ballast pump. In this manner, the backwash pump may overcome the pressure of the ballast pump and may allow for backwash water to be recycled regardless of pressure conditions generated by the ballast pump. In an embodiment, the backwash pump may also serve as an additional pump. For example, the backwash pump may act as a backwash booster pump during a ballast cycle. As another example, the backwash pump may serve as a drain pump during a system shutdown operation. In an embodiment, the backwash pump may be used to flush piping associated with the ballast treatment system. For example, the backwash pump may pump freshwater into a system to lessen the corrosive effects of seawater.

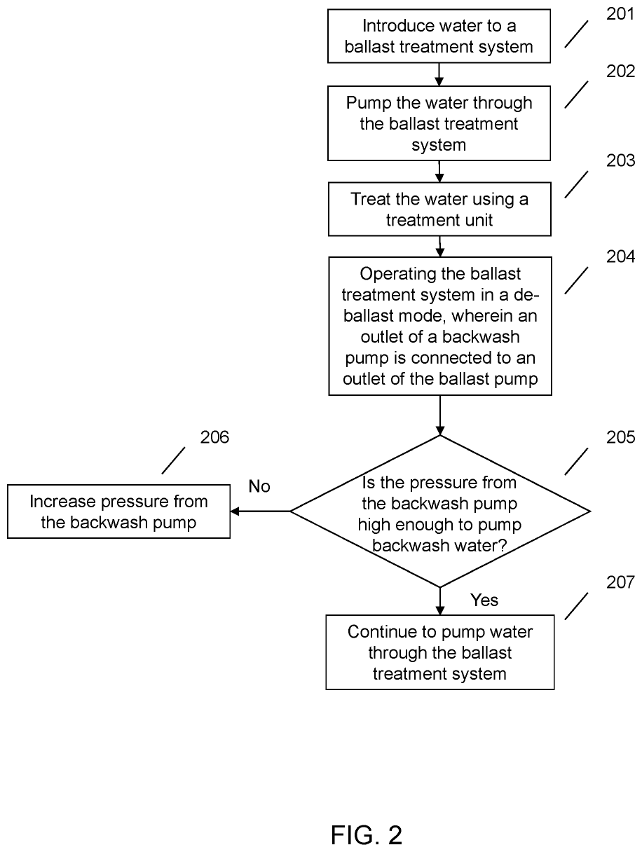

Referring to FIG. 2, an example system and method for the treatment of ballast water is illustrated. The flowchart illustration is an example mode of the ballast water treatment system, other modes are contemplated and disclosed. In an embodiment, the backwash water from the treatment unit may be introduced back into an inlet of the ballast water treatment system. The backwash may return downstream of the ballast pump. In addition to a ballast pump, there may be an additional backflow pump fluidly located downstream of the treatment unit and upstream of the inflow of the ballast pump. In this configuration backwash water is treated in both a ballast and a de-ballast mode of operation.

At 201, in an embodiment, water may be introduced to a ballast treatment system. The water may be seawater, brackish water, or freshwater. The water may be referred to as ballast water. Ballast water may be drawn from the water surrounding a ship. Thus, the ballast water may have characteristics of the water surrounding the ship. For example, in a ballast mode of operation, ballast water may be pumped into a ship using a ballast pump. Ballast may be taken aboard a ship when the ship has less or no cargo. The ballast water may provide proper trim, stability, and/or structural integrity to a ship. The ballast water may be drawn from an inlet below the water line, a sea chest, or the like.

At 202, in an embodiment, the ballast water may be pumped through the ballast water treatment system. The pumping may be performed by one or more ballast pumps. The one or more ballast pumps may be selected based upon a desired pressure, ballast water volume, or other ballast system requirements. The ballast pump may provide sufficient pressure and volume to pump ballast water through various piping valves, treatment units, to ballast tanks below and/or above the ship waterline, or the like. In an embodiment, the ballast pump may be used for de-ballasting a ship. In a de-ballast mode, ballast water may be pumped from a ballast tank to overboard. A ballast pump may also be used for redistribution of ballast water from one ballast tanks to another, for example, to re-trim a ship experiencing weather, current, wind, asymmetrically loaded cargo, or the like.

At 203, in an embodiment, the ballast water may be pumped through a treatment unit. The treatment unit may have different methods of treating the ballast water. For example, the treatment unit may have a disinfection unit. The disinfection unit may have UV light to treat the ballast water. As another example, the treatment unit may have a filtration unit. The filtration unit may have filters to filter the ballast water. The filtration unit may have filters of different pore sizes to filter at different levels based upon requirements, regulations, or quality of ballast water. The filtration unit and the disinfection unit may be in parallel or series to one another. There may be multiple filtration and/or disinfection steps in a treatment unit.

At 204, in an embodiment, the ballast water treatment system may be operated in a de-ballast mode. In a de-ballast mode, an outlet of the backwash pump may be connected to an inlet of the ballast treatment system at a point downstream of the ballast pump. Alternatively, in a ballast mode the outlet of the backwash pump may be connected to an inlet of the ballast treatment system at a point downstream of the ballast pump. The ballast pump downstream of the treatment unit may pump backwash water or filter backwash to an inlet of the ballast water treatment system. In an embodiment, the backwash water may be pumped by a backwash pump to a location downstream of the backwash pump. In an embodiment, the backwash water may be pumped by a backwash pump to a location upstream of the treatment unit. The backwash pump may feed backwash water through the filtration portion of the treatment unit, the disinfection portion of the treatment unit, or a combination thereof. In this manner, the backwash water may be properly treated from the entire ballast treatment system leaving little to no areas with possibly contaminated ballast water.

At 205, in an embodiment, the system and method may determine if the pressure from the backwash pump is sufficient to overcome the pressure of the ballast pump. For example, for a backwash pump to pump backwash water to an inlet of the ballast water treatment system, the backwash pump may need to overcome the pressure generated from the ballast pump. In other words, the output of the backwash pump may be sufficient to overcome the output of the ballast pump. In an embodiment, the backwash pump may be a type or size of pump with a larger capacity and/or higher pressure as compared to a conventional backwash water pump.

Measurement of the backwash pressure or backwash pump cycling may be at periodic intervals set by the user or preprogrammed frequencies in the device. A measurement of the backwash pressure or backwash pump cycling may be an output upon a device in the form of a display, printing, storage, audio, haptic feedback, or the like. Alternatively or additionally, the output may be sent to another device through wired, wireless, fiber optic, Bluetooth®, near field communication, or the like. An embodiment may use an alarm to warn of a measurement or backwash water pressure outside acceptable levels. An embodiment may use a system to shut down water output or shunt water from sources within unacceptable parameters, parameters, or thresholds. For example, a measuring device may use a relay coupled to an electrically actuated valve, or the like.

At 206, in an embodiment, if a pressure from the backwash water pump is not sufficient to pump backwash water to an inlet of the ballast treatment system, the system may take corrective action. For example, the system may provide an input to the backwash water pump to increase speed, increase volume, increase pressure, or the like. In an embodiment, more than one backwash pumps may be switch on to increase pressure, flow, volume, or the like. Additionally or alternatively, the system may output an alarm, log an event, or the like.

At 207, in an embodiment, if the backwash pump is properly pumping backwash water to an inflow of the ballast water system, the system may continue to pump backwash water to an inlet of the ballast treatment system. The system may connect to a communication network. The system may alert a user or a network. This alert may occur whether a backwash water is being pumped to an inlet of the ballast treatment system properly or improperly. An alert may be in a form of audio, visual, data, storing the data to a memory device, sending the output through a connected or wireless system, printing the output or the like. The system may log information such as the measurement location, a corrective action, geographical location, time, date, number of measurement cycles, a manifest of the cargo of the ship, wind speed, water currents, angle of the ship in relation to the water, or the like. The alert or log may be automated, meaning the system may automatically output whether a correction was required or not. The system may also have associated alarms, limits, or predetermined thresholds. For example, if a backwash water pressure reaches or falls below a threshold or limit. Alarms or logs may be analyzed in real-time, stored for later use, or any combination thereof.

The various embodiments described herein thus represent a technical improvement to conventional ballast water treatment techniques. Using the techniques as described herein, an embodiment may use a method and device to treat ballast water. This is in contrast to conventional methods with limitations mentioned above. Such techniques provide a better method to treat ballast water and reduce invasive species to a de-ballast port.

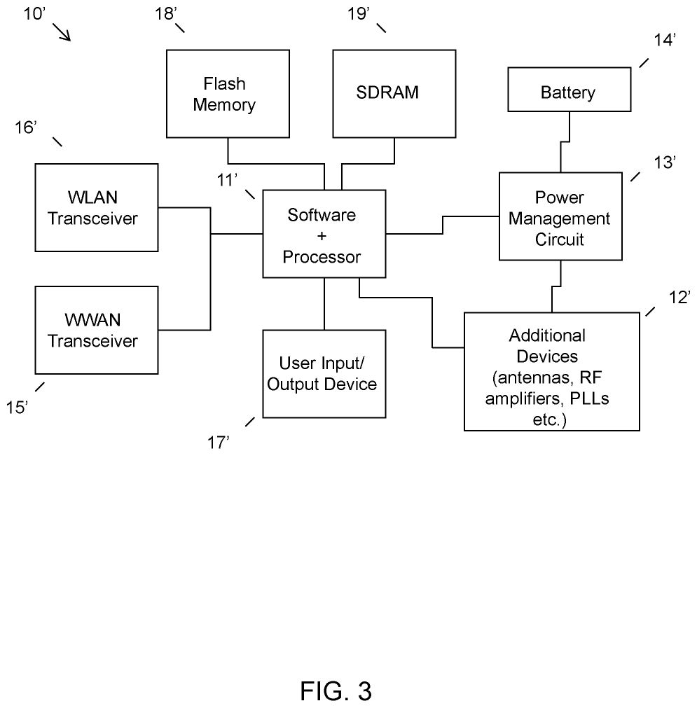

While various other circuits, circuitry or components may be utilized in information handling devices, with regard to an instrument for ballast water treatment according to any one of the various embodiments described herein, an example is illustrated in FIG. 3. Device circuitry 10′ may include a measurement system on a chip design found, for example, a particular computing platform (e.g., mobile computing, desktop computing, etc.) Software and processor(s) are combined in a single chip 11′. Processors comprise internal arithmetic units, registers, cache memory, busses, I/O ports, etc., as is well known in the art. Internal busses and the like depend on different vendors, but essentially all the peripheral devices (12′) may attach to a single chip 11′. The circuitry 10′ combines the processor, memory control, and I/O controller hub all into a single chip 11′. Also, systems 10′ of this type do not typically use SATA or PCI or LPC. Common interfaces, for example, include SDIO and I2C.

There are power management chip(s) 13′, e.g., a battery management unit, BMU, which manage power as supplied, for example, via a rechargeable battery 14′, which may be recharged by a connection to a power source (not shown). In at least one design, a single chip, such as 11′, is used to supply BIOS like functionality and DRAM memory.

System 10′ typically includes one or more of a WWAN transceiver 15′ and a WLAN transceiver 16′ for connecting to various networks, such as telecommunications networks and wireless Internet devices, e.g., access points. Additionally, devices 12′ are commonly included, e.g., a transmit and receive antenna, oscillators, PLLs, etc. System 10′ includes input/output devices 17′ for data input and display/rendering (e.g., a computing location located away from the single beam system that is easily accessible by a user). System 10′ also typically includes various memory devices, for example flash memory 18′ and SDRAM 19′.

It can be appreciated from the foregoing that electronic components of one or more systems or devices may include, but are not limited to, at least one processing unit, a memory, and a communication bus or communication means that couples various components including the memory to the processing unit(s). A system or device may include or have access to a variety of device readable media. System memory may include device readable storage media in the form of volatile and/or nonvolatile memory such as read only memory (ROM) and/or random access memory (RAM). By way of example, and not limitation, system memory may also include an operating system, application programs, other program modules, and program data. The disclosed system may be used in an embodiment to perform ballast water treatment.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device, where the instructions are executed by a processor. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and products according to various example embodiments. It will be understood that the actions and functionality may be implemented at least in part by program instructions. These program instructions may be provided to a processor of a device, e.g., a hand held measurement device, or other programmable data processing device to produce a machine, such that the instructions, which execute via a processor of the device, implement the functions/acts specified.

It is noted that the values provided herein are to be construed to include equivalent values as indicated by use of the term “about.” The equivalent values will be evident to those having ordinary skill in the art, but at the least include values obtained by ordinary rounding of the last significant digit.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A ballast water treatment system, comprising:
a ballast pump;
a backwash pump, wherein an outflow of the backwash pump is mechanically coupled to an outlet of the ballast pump;
a treatment unit, wherein the treatment unit is located fluidly between the ballast pump and the backwash pump;
wherein the ballast water treatment system has at least two modes, comprising:
a ballast mode, wherein, during the ballast mode, the ballast pump pumps water through the ballast treatment system to a ballast tank, and
a de-ballast mode, wherein, during the de-ballast mode, the backwash pump conveys backwash water to an outlet of the ballast pump.

2. The system of claim 1, wherein the treatment unit comprises a filtration system.

3. The system of claim 1, wherein the treatment unit comprises a disinfection system.

4. The system of claim 1, wherein the backwash pump provides sufficient pressure to overcome a pressure of the ballast pump.

5. The system of claim 1, the ballast treatment system comprising a drain isolation valve located downstream of the backwash pump.

6. The system of claim 5, wherein the drain isolation valve is a butterfly valve.

7. The system of claim 5, wherein the drain isolation valve operates to control a differential pressure across the ballast treatment system to a predetermined threshold.

8. The system of claim 1, wherein the back wash pump operates in the ballast mode to boost a pressure and a flow of the backwash water sent overboard.

9. The system of claim 1, wherein the backwash pump operates to drain the ballast treatment system.

10. The system of claim 1, wherein the backwash pump operates to flush the ballast treatment system with freshwater.

11. A method for ballast water treatment, comprising:
during a ballast mode, pumping using a ballast pump, water through a ballast treatment system to a ballast tank, wherein the ballast treatment system comprises a treatment unit, wherein the treatment unit is located fluidly between the ballast pump and the backwash pump; and
during a de-ballast mode, pumping using a backwash pump backwash water to an outlet of the ballast pump, wherein an outflow of the backwash pump is mechanically coupled to an outlet of the ballast pump.

12. The method of claim 11, wherein the treatment unit comprises a filtration system.

13. The method of claim 11, wherein the treatment unit comprises a disinfection system.

14. The method of claim 11, wherein the backwash pump provides sufficient pressure to overcome a pressure of the ballast pump.

15. The method of claim 11, the ballast treatment system comprising a drain isolation valve located downstream of the backwash pump.

16. The method of claim 15, wherein the drain isolation valve is a butterfly valve.

17. The method of claim 15, wherein the drain isolation valve operates to control a differential pressure across the ballast treatment system to a predetermined threshold.

18. The method of claim 11, wherein the back wash pump operates in the ballast mode to boost a pressure and a flow of the backwash water sent overboard.

19. The method of claim 11, wherein the backwash pump operates to drain the ballast treatment system.

20. A product, comprising:
a storage device that stores code, the code being executable by a processor and comprising:
code that during a ballast mode, pumps using a ballast pump, water through a ballast treatment system to a ballast tank, wherein the ballast treatment system comprises a treatment unit, wherein the treatment unit is located fluidly between the ballast pump and the backwash pump; and
code that during a de-ballast mode, pumps using a backwash pump backwash water to an outlet of the ballast pump, wherein an outflow of the backwash pump is mechanically coupled to an outlet of the ballast pump.
